(19) United States
(12) Patent Application Publication
(10) Pub. No.: US 2020/0399537 A1
(43) Pub. Date: Dec. 24, 2020

(54) Liquid Crystal for Longwave Infrared Applications

(71) Applicant: The Government of the United States of America, as represented by the Secretary of the Navy, Arlington, VA (US)

(72) Inventors: Jawad Naciri, Arlington, VA (US); Christopher M. Spillmann, Annandale, VA (US); Jakub Kolacz, Washington, DC (US); Henry G. Gotjen, Washington, DC (US); Jason D. Myers, Alexandria, VA (US); Jesse A. Frantz, Washington, DC (US); Robel Y. Bekele, Washington, DC (US)

(21) Appl. No.: 16/668,292

(22) Filed: Oct. 30, 2019

Related U.S. Application Data
(60) Provisional application No. 62/753,250, filed on Oct. 31, 2018.

(51) Int. Cl. C09K 19/06; G02F 1/1335; G02F 1/137

(52) U.S. Cl. CPC C09K 19/062; C09K 2019/122; G02F 1/137; G02F 1/133528

(57) ABSTRACT

Liquid crystal molecules are described with desirably reduced attenuation in portions of the long-wave infrared (LWIR) spectrum. The molecules include a linear hydrocarbon of varying length (CₙH₂ₙ₊₁, where n, for example, is from 4-7), a deuterated phenyl core comprising 2 or 3 rings, and one terminal cyano group. These enable electro-optic such as light modulators, phased arrays, polarization gratings, refractive steerers, and the like, operable at LWIR.

### CROSS-REFERENCE TO RELATED APPLICATIONS

This Application claims the benefit of U.S. Provisional Application 62/753,250 filed on Oct. 31, 2019, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing NC 109,380.

### BACKGROUND

Liquid crystal is phase of matter describing a fluid with orientational and/or positional order. An organic liquid crystal mixture typically consists of self-assembled rod- or disk-shaped molecules with long-range order, giving rise to anisotropic properties such as birefringence (Δn), dielectric anisotropy (Δε), and diamagnetic susceptibility (Δχ). These properties arise from the aggregate behavior of the molecules, which typically possess an electron-conjugated core combined with aliphatic chains to stabilize the temperature-dependent phase behavior. The birefringence of liquid crystal derived from rod-shaped molecules can be voltage tuned (due to reorientation of the molecular dipoles to the applied field) and has been utilized extensively in the display industry and a wide range of electro-optic devices ranging from light (phase, amplitude, polarization) modulators (Konforti, Marom et al. 1988, Wu and Wu 1989, Davis, McNamara et al. 2000), phased arrays (McManamon, Watson et al. 1993, McManamon, Dorschner et al. 1996), polarization gratings (Komanduri and Escuti 2009, Kim, Oh et al. 2011, Kim, Miskiewicz et al. 2015), and refractive steerers (Davis, Farca et al. 2008, Davis, Farca et al. 2010, Frantz, Myers et al. 2017). These applications have been realized across a wide range of the electromagnetic spectrum, spanning the visible (—400-˜700 nm) to mid-wave infrared (˜3-5 μm) bands.

Most electro-optic applications rely on the efficient throughput of light. Depending on the spectral range, the incorporation of LC mixtures may introduce certain challenges. At shorter wavelengths, i.e. the visible regime, scattering losses are from two main sources: first, Rayleigh scattering (proportional to inverse fourth power of wavelength) and second, collective orientational fluctuations of the molecular axis. The latter can be a significant source of loss based on the large molecular anisotropy and relatively weak thermal energy needed to excite molecular fluctuations (Degennes 1969, Giallorenzi and Sheridan 1975). These losses are typically minimized by keeping the transmission path length short—typically on the order of 10 s of microns or less. In the near infrared (NIR) and shortwave infrared (SWIR), these scattering contributions, particularly Rayleigh scattering, become less significant with the increased wavelength of the EM radiation. Further into the infrared (˜3-14 μm), i.e. the midwave (MW-) and longwave infrared (LWIR), scattering no longer dominates, but absorption becomes significant. The main cause is intrinsic absorption peaks directly related to fundamental resonant molecular vibrations of particular bonds. In organic molecules, various carbon-carbon (C—C) and carbon-hydrogen (C—H) vibration modes are the most common, though many other exist and this is why the MW/LWIR bands are referred to as the molecular fingerprint regime. For molecules in an LC mixture, absorption peaks from others bonds, particularly those contributing to the permanent molecular dipole moment, e.g.-cyano (—CN), tend to be very strong.

In the design of IR electro-optic devices incorporating LC, a critical consideration is the composition of the LC mixture itself. Previously, LC molecules and mixtures optimized for the MWIR have been developed (Wu, Wang et al. 2002, Chen, Xianyu et al. 2011, Hu, An et al. 2014, Peng, Chen et al. 2014, Peng, Lee et al. 2015). These have included general approaches such as substituting C—H with carbon-deuterium (C-D) bonds (Gray and Mosley 1978, Wu, Wang et al. 2002) and also developing molecules with aliphatic (C—H) chains substituted for chains composed of carbon-fluorine (C—F) repeat units (Chen, Xianyu et al. 2011). The former (partially or fully deuterated molecules), was first described several decades ago as a means to study the phase of LC molecules using inelastic neutron scattering.

A need exists for new liquid crystal materials suited for use in IR applications.

### BRIEF SUMMARY

Described herein is a class of organic liquid crystal (LC) materials with low molecular absorption in portions of the long-wave infrared (LWIR). The invention is further directed to methods for making the LC materials, and to LC-based electro-optic (E-O) devices containing them.

In one embodiment, a liquid crystal molecule comprises a C—H chain having the formula CₙH₂ₙ₊₁ where n is from 4 to 7, inclusive, a deuterated phenyl core comprising 2 or 3 rings, and one terminal cyano group positioned opposite to the C—H chain.

In a further embodiment, an electro-optic device includes a liquid crystal (LC) comprising molecules having a C—H chain of varying length (CₙH₂ₙ₊₁), a deuterated phenyl core comprising 2 or 3 rings, and one terminal cyano group; and at least one electrode configured to apply a voltage to the liquid crystal effective to alter optical properties of the liquid crystal.

In another embodiment, a method of preparing a deuterated liquid crystal molecule involves reacting 1-phenylpentane-d5 with bromine to produce 1-bromo-4-pentylbenzene-d4; reacting the 1-bromo-4-pentylbenzene-d4 with butyl-lithium and tri-isopropyl borate to produce (4-pentylphenyl)boronic acid-d4; and reacting the (4-pentylphenyl)boronic acid-d4 with 4-bromobenzonitrile-d4, tetrakis(triphenylphosphine)palladium (0) and aqueous sodium carbonate to produce 4′-pentyl-[1,1′-biphenyl]-4-carbonitrile-d8.

### BRIEF DESCRIPTION OF THE DRAWINGS

FIGS. 1A and 1B schematically show operation of an liquid crystal based electro-optic device.

FIG. 2 is a schematic of a refractive steerer.

FIG. 3 shows a synthetic scheme for preparing the LWIR liquid crystal materials.

FIG. 4 shows various LC molecules prepared as described herein.

FIG. 5 displays the midwave and longwave infrared (3.5-14 μm) attenuation profile of partially deuterated 5CBd8 compared to the standard 5CB molecular signature.

FIG. 6 provides the attenuation profiles of various LC molecules.

FIG. 7 shows various LC molecules prepared as described herein.

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

### Overview

The invention relates to molecules showing a nematic liquid crystal phase and reduced absorption in select regions of the LWIR. The molecules comprise a series of at least partially deuterated, cyano-based molecules. These molecules have a C—H tail and a deuterated phenyl-ring core. A cyano (C—N) bond at one end of the molecule provides a strong molecular dipole and response to an applied field, while also increased birefringence from extended electron delocalization.

In embodiments, the series of molecules comprises a C—H chain of varying length (CₙH₂ₙ₊₁), a deuterated phenyl core comprising 2 or 3 rings, and one terminal cyano group. Combined, this series of molecules exhibits a strong response to an applied field and increased birefringence from extended electron delocalization.

In the LWIR spectral region, several prominent and overlapping resonant vibration modes from C—C and C—H bonds combine for relatively large absorption losses (here defined as >10 cm⁻¹). For an LC electro-optic device to function in the LWIR, the LC molecular composition should be engineered to minimize vibrational modes or shift some of them out of spectral bands of interest. For LC applications, C—C bonds within the molecular core are considered unavoidable and necessary as the conjugated phenyl rings give rise to electron delocalization and concomitant anisotropic molecular properties. On the other hand, C—H bonds are addressable in the sense that the hydrogen may be substituted for deuterium. The increased molecular mass associated with the C-D bond lowers (increases) the resonant molecular vibration frequency (wavelength) outside of the spectral bands of interest according to:

ω=\sqrt{κ/μ} (1)

where ω is the molecular vibration frequency (equal to the inverse of the wavelength), κ is the molecular spring constant, and μ is the reduced diatomic mass of the bond.

Frequently in molecules showing an LC phase, there are many vibrational modes associated with the C—H bonds in both the alkane chain and phenyl ring structures. Three prominent ones are the C—H stretch as well as the in-plane and out-of-plane bending modes. For aromatics, the mode and associated spectral ranges are as follows: C—H stretch (˜3.2-3.3 μm); in-plane (˜8-10 μm) bending; out-of-plane bending (˜11-14 μm). Because the latter two fall within the LWIR spectral region, there is opportunity to shift these modes to longer wavelengths by substituting hydrogen with deuterium. Performing a similar function to the alkane chain is unnecessary since the most prominent vibrational modes fall within the MWIR spectral range.

In terms of the molecular dipole moment, there are also select groups that are presently-preferred for different spectral bands, including the LWIR. The most typical molecular dipole groups are (in order of their absorption peak range): cyano (—CN), isothiocyanate (—NCS), nitro (—NO₂), carboxyl (—CO), and halogens (—F, —Cl, —Br). Halogens have absorption peaks in the LWIR (—F: 9-10 μm, —Cl: 12.5-16 μm, —Br: 16-20 μm), with the latter two (—Cl and —Br) being such bulky groups that they tend to disturb the LC phase stability. Carboxyl groups also have absorption peaks in the 7-10 μm range that are strong and also broad. Nitro groups possess strong peaks in the 6-6.5 μm range, though the majority of molecules with these groups tending to form smectic liquid crystal phase.

Described herein is the development and characterization of a series of partially (ring-) deuterated molecules with the primary purpose for use in LC-based electro-optic devices and applications in regions of the LWIR spectrum (˜8-14 μm). Although it is likely not possible to develop a mixture with low absorption throughout the entire LWIR spectral range, through targeted molecular engineering certain bonds contributing to vibrations in the LWIR can be altered to shift their absorption peaks. It should also be noted that low absorption (high transmission) is not the only criteria for operation in the LWIR. An LC mixture should also possess the following characteristics: a stable nematic LC phase; moderate birefringence (Δn>0.1); and good dielectric anisotropy (Δε>8). Combined, these qualities provide an LC mixture useful for electro-optic applications in the LWIR

### EXAMPLES

The LWIR LC mixtures of the invention can be incorporated into a wide range of LC-based electro-optic (E-O) devices (e.g., light modulators, phased arrays, polarization gratings, refractive steerers, and the like). Two examples, a simple E-O transmissive device and a refractive steerer, are further described as follows.

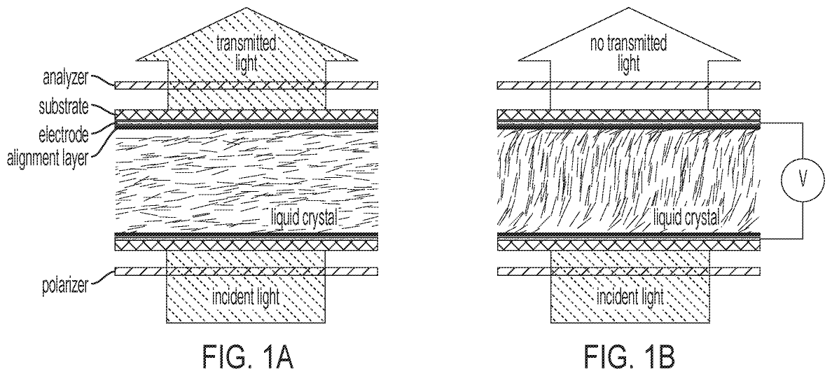

In the first example, light passes through the bulk LC and is modulated by re-aligning the LC in response to an applied voltage (FIGS. 1A-1B). Linearly polarized incident light passes through the LC and is transmitted through an analyzer (FIG. 1A). The polarizer and analyzer are rotated by 90° with respect to each other, i.e. crossed. Further, the crossed polarizer/analyzer are themselves rotated such that they are at a 45° with respect to the preferred alignment direction of the LC, referred to as the nematic director. In the absence of a voltage, polarized light interacts with the aligned LC (having a refractive index associated with the long axis of the rod-shaped molecule: extraordinary index, ne) resulting in a phase shift such that light is transmitted through the analyzer. If a voltage is applied to the E-O device, the rod-like molecules will re-orient to align with the direction of the applied field (FIG. 1B). Anchoring forces associated with the LC alignment layer inhibit reorientation of molecules closer to the edge of the device. In this case, light interacting with the bulk LC that has realigned with the applied field (thus interacting with the short axis of the molecule and its associated refractive index: ordinary index, no) experiences a phase shift much lower in magnitude such that essentially no light is transmitted. In this voltage-tuned manner the phase of the polarized light is altered and affects the extent to which light is transmitted through the E-O device. Note: though the LC materials are optimized to operate in bands of the LWIR, the other components of the device (polarizers, substrates, electrodes, and LC aligning layers) also have to be selected such that they are transmissive to LWIR light.

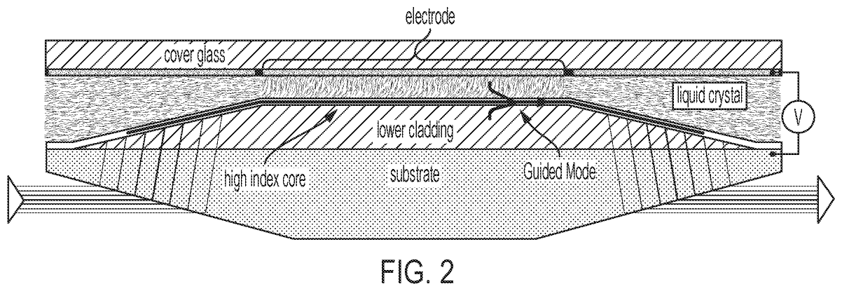

The second example is a refractive steerer, where the evanescent field of a coupled, guided mode in a planar waveguide interacts with an upper LC cladding (FIG. 2). Modulation of an applied voltage reorients the LC tuning its refractive index and, therefore, the effective index of the waveguide. Patterned upper electrodes allows the guided mode to be redirected in a refractive manner for beam steering applications. In this embodiment, the various layers of the waveguide interacting with the guided mode (including the LC) should have maximal transmission in the spectral band(s) of interest, i.e. LWIR, especially given the extended path length of the device, which on the order of centimeters). For a device designed to operate in the LWIR, the LC described herein preferably has minimized absorption.

In the examples shown in FIGS. 1 and 2, it is beneficial to minimize sources of loss that will decrease the throughput efficiency of the devices. The incorporation of LC mixtures designed for reduced absorption losses is a preferred way to achieve an optimized throughput in addition to incorporating LWIR transmissive components for the rest of the device.

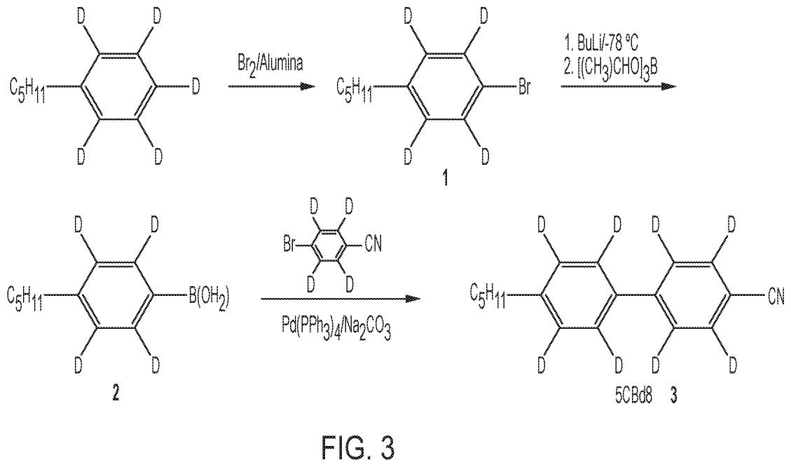

A synthetic scheme for preparing the LWIR liquid crystal materials of the invention is shown in FIG. 3, and described for the partially deuterated molecule termed 5CBd8. Though a different synthetic scheme has been described previously (Gray and Mosley 1978), it relied upon synthetic steps and purification techniques that are difficult to carry out. The synthetic scheme of the invention beneficially provides a more cost-effective and simpler way to prepare the LC materials.

1-Bromo-4-pentylbenzene-d4 (1): In an 125 mL flask, bromine (2.87 g, 0.92 mL, 17.98 mmol) was absorbed onto neutral grade I alumina (14 g). In another flask, 1-phenylpentane-d5 (2.5 g, 2.91 mL, 17.98 mmol) was absorbed onto alumina (14 g). The content of both flasks were combined in a 250 mL flask and stirred for 3 min. The reaction was complete as indicated by the disappearance of bromine color. The solid was poured in a column with silica gel and eluted with hexanes to yield an oil product. Yield 2.2 g.

(4-pentylphenyl)boronic acid-d4 (2): Butyl-lithium (2.47 mL, 2.5 M in hexanes) was added dropwise to a stirred, cooled (−78° C.) solution of compound 1 (1.43 g, 6.19 mmol) in dry THF under nitrogen. The reaction mixture was maintained under these conditions for 2.5 h and then a previously cooled solution of tri-isopropyl borate (3 mL, 12.9 mmol) in dry THF (5 mL) was added dropwise at −78° C. The reaction mixture was allowed to warm to room temperature overnight and the stirred for 1 h with 10% HCl (10 mL). The product was extracted into ether (twice), and the combined ethereal extracts were washed with water and dried (MgSO₄). The solvent was removed in vacuum to yield colorless crystals.

4′-pentyl-[1,1′-biphenyl]-4-carbonitrile-d8 (3): A solution of compound 2 (0.5 g, 2.55 mmol) in ethanol (3 mL) was added to a stirred mixture of 4-bromobenzonitrile-d4 (0.39 g, 2.1 mmol), tetrakis(triphenylphosphine)palladium (0) (0.075 g, 0.064 mmol) in benzene (15 mL) and aqueous sodium carbonate (15 mL, 2M) at room temperature under nitrogen. The stirred mixture was heated under reflux (90° C.) for 24 h. The product was extracted into ether (twice) and the combined ethereal extracts were washed with brine and dried over MgSO₄. The solvent was removed in vacuum and the residue was purified by column chromatography (silica gel, hexanes/ethyl acetate 5/1) to yield compound 3.

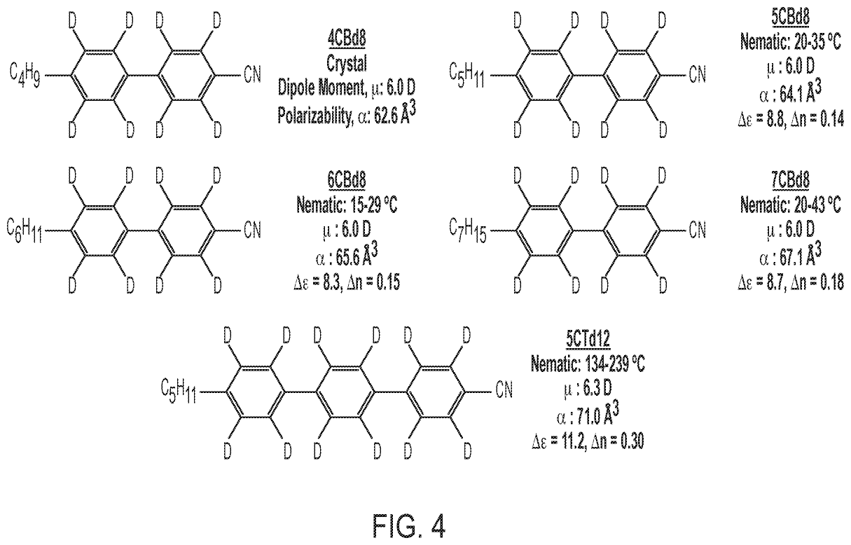

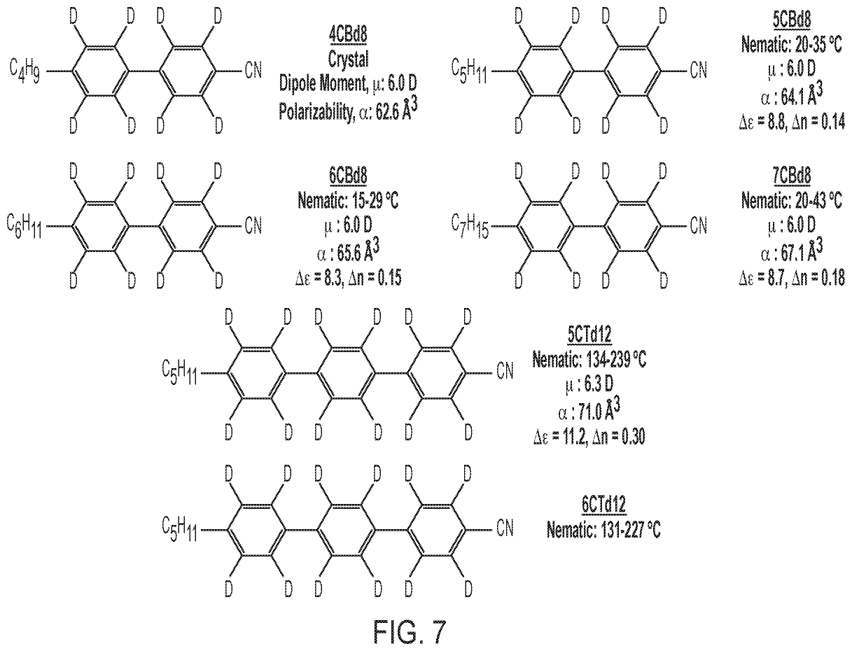

Several variant molecules were synthesized and their properties (including transmission, birefringence, and phase behavior) determined. The phase behavior, dipole moment, polarizability, birefringence, and dielectric properties are shown in FIGS. 4 and 7.

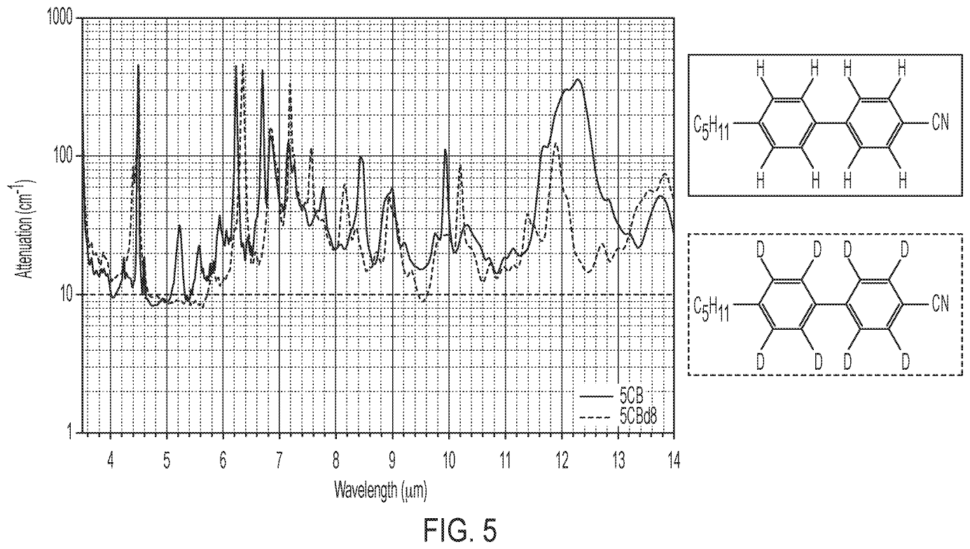

FIG. 5 displays the midwave and longwave infrared (3.5-14 μm) attenuation profile of partially deuterated 5CBd8 compared to the standard 5CB molecular signature and gives a general indication of the differences when only the hydrogen atoms on the phenyl rings are replaced with deuterium. These measurements were collected on an FTIR spectrometer (Buker Vertex 70) in the following manner. First, a cell of known thickness (˜20 microns or less) was constructed of MW/LWIR transparent substrates (e.g. NaCl or KBr) and Mylar or Teflon spacers. The substrate materials also had to possess a refractive index that was similar to the ordinary index (nₒ) of the nematic LC phase of the material of interest. For the majority of materials with an LC phase this value is ˜1.5. The cell was mounted on a temperature controlled stage in the path of the IR light of the FITR spectrometer. An initial spectrum was obtained of the empty cell to determine the cell thickness, t, based on the fringe pattern and the expression.

$$t = \frac{N {λ}_{1} {λ}_{2}}{2 ( {λ}_{2} - {λ}_{1} )}$$

where N is the number of maximum or minimum fringes and λ₁ and λ₂ are the two wavelengths of the first and last max or min fringes. The cell was then filled with the material of interest and heated to the isotropic phase (˜10° C. above the clearing temperature, T_{NI}). The material was heated to avoid significant scattering contributions, particularly since there was not a LC alignment layer applied to the cell interfaces in contact with the LC mixture. Transmission/absorption spectra from the samples were collected across the infrared spectrum and corrected to account for the Fresnel reflection losses from the substrate windows and air interfaces. The reflection losses associated with the LC/substrate interface were neglected due to the low refractive index contrast between the two materials. The result of such analysis is plotted in FIG. 5. Of particular interest is the drop in the change in the attenuation found between 9 and 11 microns

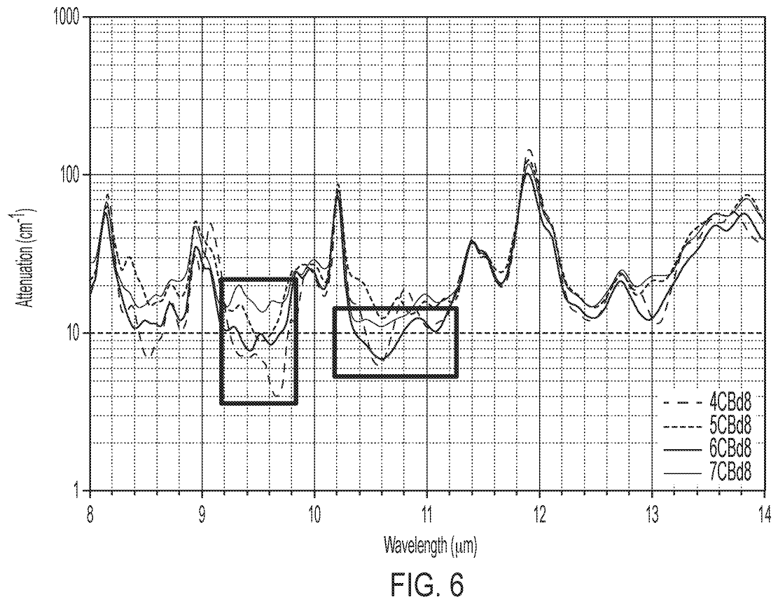

The reduction in the attenuation in the LWIR is further highlighted in FIG. 6, where the profile of four partially deuterated variants (4CBd8, 5CBd8, 6CBd8, and 7CBd8) are plotted. As with FIG. 5, a reference line at 10 cm¹ has been added. This attenuation value (or lower) has been deemed an acceptable value for LC absorption for certain applications with a short path length or partial interaction of the guided mode, e.g. in a waveguide with LC acting as a cladding. As shown in FIG. 6, there are windows of reduced attenuation associated with selective deuteration of the phenyl core. The most prominent are observed with 4CBd8 and 6CBd8, perhaps revealing some additional influence related to the odd/even number of carbon atoms in the alkane chain (C=4, 6 lower attenuation; C=5, 6 higher attenuation).

These results are the first demonstration of series of molecules showing a nematic LC phase with relatively low light attenuation in select regions of the LWIR. In general, the LWIR is a high absorption region for any organic molecule, LC being no exception. However, the invention has successfully demonstrated the ability to reduce the attenuation profile of certain molecules in the LWIR for LC-based electro-optic applications.

### Further Embodiments

The alkane tail length may be varied to maintain a reduced attenuation in the LWIR. Moreover, the number of deuterated phenyl rings may be varied to maintain a reduced attenuation in the LWIR. Also, the number of cyano groups may be varied on each of the phenyl rings; this can act to increase the anisotropic properties while still reducing the attenuation in select regions of the LWIR. Other molecular dipole groups besides cyano, e.g. isothiocyanate (—NCS), nitro (—NO2), carboxyl (—CO), and halogens (—F, —Cl, —Br) may be used to provide the dielectric anisotropy.

Advantages

The invention provides a class of organic materials with a reduced attenuation profile in select regions of the longwave infrared (LWIR) spectrum. The materials possess a nematic liquid crystal phase, providing opportunity for incorporation of these materials in electro-optic applications in the LWIR. Furthermore, the materials maintain good anisotropic properties (birefringence, dielectric anisotropy) for applications in the LWIR. Individual materials may be combined to produce an LC mixture with an expanded temperature range in the nematic phase combined with reduced attenuation in the LWIR.

Concluding Remarks

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

### REFERENCES

Chen, Y., H. Q. Xianyu, J. Sun, P. Kula, R. Dabrowski, S. Tripathi, R. J. Twieg and S. T. Wu (2011). “Low absorption liquid crystals for mid-wave infrared applications.” Optics Express 19(11): 10843-10848.
Davis, J. A., D. E. McNamara, D. M. Cottrell and T. Sonehara (2000). “Two-dimensional polarization encoding with a phase-only liquid-crystal spatial light modulator.” Applied Optics 39(10): 1549-1554.

Davis, S. R., G. Farca, S. D. Rommel, S. Johnson and M. Anderson (2010). Liquid crystal waveguides: new devices enabled by >1000 waves of optical phase control. SPIE, SPIE.
Davis, S. R., G. Farca, S. D. Rommel, A. W. Martin and M. Anderson (2008). Analog, Non-Mechanical Beam-Steerer with 80 Degree Field of Regard. SPIE, Proc. SPIE.
Degennes, P. G. (1969). “Long Range Order and Thermal Fluctuations in Liquid Crystals.” Molecular Crystals and Liquid Crystals 7: 325-&.
Frantz, J. A., J. D. Myers, R. Y. Bekele, C. M. Spillmann, J. Naciri, J. S. Kolacz, H. Gotjen, L. B. Shaw, J. S. Sanghera, B. Sodergren and Y. J. Wang (2017). Non-mechanical beam steering in the mid-wave infrared. SPIE, SPIE.
Giallorenzi, T. G. and J. P. Sheridan (1975). “Light-Scattering from Nematic Liquid-Crystal Waveguides.” Journal of Applied Physics 46(3): 1271-1282.
Gray, G. W. and A. Mosley (1978). “Synthesis of Deuteriated 4-N-Alkyl-4′-Cyanobiphenyls.” Molecular Crystals and Liquid Crystals 48(3-4): 233-242.
Hu, M. G., Z. W. An, J. Li, L. C. Mo, Z. Yang, J. L. Li, Z. Y. Che and X. Z. Yang (2014). “Tolane liquid crystals bearing fluorinated terminal group and their mid-wave infrared properties.” Liquid Crystals 41(12): 1696-1702.
Kim, J., M. N. Miskiewicz, S. Serati and M. J. Escuti (2015). “Nonmechanical Laser Beam Steering Based on Polymer Polarization Gratings: Design Optimization and Demonstration.” Journal of Lightwave Technology 33(10): 2068-2077.
Kim, J., C. Oh, S. Serati and M. J. Escuti (2011). “Wide-angle, nonmechanical beam steering with high throughput utilizing polarization gratings.” Applied Optics 50(17): 2636-2639.
Komanduri, R. K. and M. J. Escuti (2009). “High efficiency reflective liquid crystal polarization gratings.” Applied Physics Letters 95(9).
Konforti, N., E. Marom and S. T. Wu (1988). “Phase-Only Modulation with Twisted Nematic Liquid-Crystal Spatial Light Modulators.” Optics Letters 13(3): 251-253.

McManamon, P. F., T. A. Dorschner, D. L. Corkum, L. J. Friedman, D. S. Hobbs, M. Holz, S. Liberman, H. Q. Nguyen, D. P. Resler, R. C. Sharp and E. A. Watson (1996). “Optical phased array technology.” Proceedings of the Ieee 84(2): 268-298.

McManamon, P. F., E. A. Watson, T. A. Dorschner and L. J. Barnes (1993). “Applications Look at the Use of Liquid-Crystal Writable Gratings for Steering Passive Radiation.” Optical Engineering 32(11): 2657-2664.
Peng, F. L., Y. Chen, S. T. Wu, S. Tripathi and R. J. Twieg (2014). “Low loss liquid crystals for infrared applications.” Liquid Crystals 41(11): 1545-1552.
Peng, F. L., Y. H. Lee, H. W. Chen, Z. Li, A. E. Bostwick, R. J. Twieg and S. T. Wu (2015). “Low absorption chlorinated liquid crystals for infrared applications.” Optical Materials Express 5(6): 1281-1288.
Wu, S. T., Q. H. Wang, M. D. Kempe and J. A. Kornfield (2002). “Perdeuterated cyanobiphenyl liquid crystals for infrared applications.” Journal of Applied Physics 92(12): 7146-7148.
Wu, S. T. and C. S. Wu (1989). “High-Speed Liquid-Crystal Modulators Using Transient Nematic Effect.” Journal of Applied Physics 65(2): 527-532.

What is claimed is:

1. A liquid crystal molecule consisting of:
a C—H chain having the formula CₙH₂ₙ₊₁ where n is from 4 to 7, inclusive, a deuterated phenyl core comprising 2 or 3 rings, and one terminal cyano group positioned opposite to the C—H chain.

2. The liquid crystal molecule of claim 1, selected from the group consisting of 4CBd8, 5CBd8, 6CBd8, 7CBd8, 5CTd12, and 6CTd12.

3. An electro-optic device comprising:
a liquid crystal (LC) comprising molecules consisting of a C—H chain of varying length (CₙH₂ₙ₊₁), a deuterated phenyl core comprising 2 or 3 rings, and one terminal cyano group; and
at least one electrode configured to apply a voltage to the liquid crystal effective to alter optical properties of the liquid crystal,
wherein the molecules are selected from the group consisting of 4CBd8, 5CBd8, 6CBd8, 7CBd8, 5CTd12, and 6CTd12.

4. The device of claim 3, wherein the device is configured as a light modulator, phased array, polarization grating, and/or refractive steerer.

5. The device of claim 4, further comprising a polarizer positioned to polarize incident light before it arrives at the LC and an analyzer positioned to receive the light after it has passed through the LC.

6. The device of claim 4, configured as the refractive steerer, and further comprising a lower cladding positioned opposite the electrode.

7. A method of preparing a deuterated liquid crystal molecule, comprising:
reacting 1-phenylpentane-d5 with bromine to produce 1-bromo-4-pentylbenzene-d4;
reacting the 1-bromo-4-pentylbenzene-d4 with butyl-lithium and tri-isopropyl borate to produce (4-pentylphenyl)boronic acid-d4; and
reacting the (4-pentylphenyl)boronic acid-d4 with 4-bromobenzonitrile-d4, tetrakis(triphenylphosphine)palladium (0) and aqueous sodium carbonate to produce 4′-pentyl-[1,1′-biphenyl]-4-carbonitrile-d8.
